(19) United States
(12) Patent Application Publication
(10) Pub. No.: US 2013/0129929 A1
(43) Pub. Date: May 23, 2013

(54) Sensor for Registering a Measurement Variable of a Medium

(71) Applicant: Endress + Hauser Conducta Gesellschaft fur Mes, Gerlingen (DE)

(72) Inventors: Katrin Scholz, Bobritzsch (DE); Dustin Roschutz, Geithain (DE); Michael Hanko, Dresden (DE); Steffi Kronert, Limach-O (DE)

(73) Assignee: Endress + Hauser Conducta Gesellschaft fur Mess- und Regeltechnik + Co. KG, Gerlingen (DE)

(21) Appl. No.: 13/676,544

(22) Filed: Nov. 14, 2012

(30) Foreign Application Priority Data
Nov. 17, 2011 (DE) 10 2011 086 585.3

(51) Int. Cl. C09D 5/14; G01B 21/30; G01B 11/30

(52) U.S. Cl. CPC C09D 5/14; G01B 11/30; G01B 21/30; B82Y 30/00
USPC 427/421.1; 356/600; 73/105; 204/400; 204/433; 204/416; 977/779

(57) ABSTRACT

A sensor for registering a measurement variable of a medium, comprising a sensing body with a section of surface area, which is exposed to the medium to register the measurement variable, whereby a condition of the section of surface area affects the provided value of the measured measurement variable, whereby the section of surface area comprises a coating that comprises nanoparticles. The coating, which comprises the nanoparticles, comprises at least one nano polymer.

The invention concerns a sensor for registering a measurement variable of a medium, such as an electrochemical or an optical sensor for example.

Sensors of this sort are oftentimes employed to monitor industrial processes or environmental parameters. In the environmental sector, in particular in the area of water supply and treatment, are measurement variables that are important to monitor such as the pH value, the concentration of dissolved O₂, the conductivity or concentration of various chemical substances, for example, the concentration of cations such as Na⁺ or NH₄⁺ or of anions such as Cl⁻, PO₄²⁻, NO₃⁻, NO₂⁻. Likewise, in industrial processes, such as in processes in the food and beverage industry for example, the chemical industry, the pharmaceutical industry and in biotechnology, these, and other measurement variables such as temperature or pressure, play an important role.

A large number of electrochemical sensors, such as, for example, potentiometric sensors or ampero-metric sensors, are employed in such processes or in the environmental sector. To register the pH value of a medium, a potentiometric sensor with a glass electrode, serving as a measurement half-cell, and an electrode of the second kind, for example an Ag/AgCl reference electrode, serving as a reference half-cell, can be used. Ampero-metric sensors that function according to the Clark electrode principle are often employed to register dissolved O₂. Ion concentrations can be determined through electrochemical analysis by means of ion-selective electrodes. Alternatively, the pH value or concentrations of other substances can also be recorded by means of an ISFET sensor, which comprises a ion-selective field effect transistor.

The pH value, the dissolved O₂ content and also the concentration of chemical substances, e.g. ion concentrations, can also be determined by means of optical sensors. Optical sensors can work, for example, according to the photometric principle, wherein EM radiation of at least one wavelength is passed through the medium that is to be monitored, and the relevant measurement variable is ascertained according to the absorption of at least one wavelength by the medium. Another group of optical sensors comprises a measurement partition in which a chemical substance is immobilized, whose optical properties, its color or luminescent or fluorescent properties for example, vary with its dependence on the measurement variable that is to be determined.

Something that all of these sensors have in common is that, in order to determine the desired measurement variable, a section of surface area of the respective sensor, for example, the glass partition of a glass electrode, the Gate of an ISFET sensor, the measuring partition or a window section of an optical sensor, is brought into contact with the medium. A diaphragm of a reference electrode can also, by way of example, be a part of the section of the surface area of a potentiometric sensor, which stands in contact with medium for the purpose of measurement.

In the case of a potentiometric pH-meter, such as a single rod measuring cell comprising a glass electrode measurement half-cell and an Ag/AgCl reference electrode as a reference half-cell for example, the measurement value can be derived from an electric potential difference between measurement and reference half-cell in contact with the medium. The condition of the section of surface area that is in contact with the medium plays an important role in the process of determining the measurement variable. If the section of surface area, for example the measurement partition or the measurement half-cell and/or the diaphragm of the reference half-cell, is damaged or contaminated, then this leads to an inaccuracy in the measurement value. Similar considerations apply for ion-selective electrodes and ISFET sensors and are also applicable to ampere-metric sensors.

In optical sensors as well, in accordance with the relevant measuring principle, the condition of the section of surface in contact with the medium, e.g. an optical window or a measuring partition, influences the value of the measurement variable. Because of this, in these sensors as well, the value of the measurement variable can be corrupted on the basis of undesirable contamination of the section of surface area.

The measurement influencing fouling or contamination on the section of surface area of the sensor can occur, for example, from an accumulation of grime on the surface, or from the surface growth of a microorganism, such as for example, bacteria or algae. If such a contamination or growth as the case may be, takes place, then the sensor must be serviced, for example cleaned and/or recalibrated.

In DE 10 2007 049 013 A1 it is proposed that the section of surface area of the sensor exposed to the medium be coated with a substance with biocidal properties, in order to prevent the adsorption of proteins or other substances present in biological processes, which contaminate the surface of the sensor and influence the value of the measurement variable. Polyethylene glycol (PEG) is named as an example of a material that as a coating is functionally a biocide. If the section of surface area is composed of glass, then the PEG coating can be coupled to the section of surface area by means of a silane species reagent, in order to prevent the dissolution of the coating during a cleaning or sterilization process.

Indeed, with the coating described in DE 10 2007 049 013 A1, satisfactory results are achieved. However, in order to apply the coating, and in particular to bind the polyethylene glycol to the section of surface area, a whole series of production steps are required. Firstly, a cleaning and activation step occurs, wherein the section of surface area is initially treated with Caro's Acid (“Piranha solution”), which is obtained from the combining of a 30% solution of H₂O₂ with concentrated sulfuric acid at a ratio of 1:1, and subsequently, silane groups are formed on the section of surface area via a silanization reagent, e.g. (3 aminopropyl) triethoxysilane (APTES). In further subsequent steps, the PEG is coupled to the silane groups. All of these steps necessitate the use of a number of chemicals, some of which are severely caustic, or at the very least irritant. The method of applying the PEG coating that is functionally a biocide must therefore be conducted by appropriately trained personnel, and the chemicals, after application, must be disposed of properly. The appropriate safety measures must be taken for personnel and the environment.

It is the object of the invention to specify sensors of the kind mentioned above, whereby in order to guarantee reliable measurement values, the sensors of the kind mentioned above are protected against the accumulation of grime and/or the growth of biological layers, whereby the previously mentioned disadvantages of the prior art are avoided.

This object will be solved according to the invention by a sensor for registering a measurement variable of a medium, comprising a sensing body with a section of surface area, which is exposed to the medium to register the measurement variable, whereby a condition of the section of surface area affects the provided value of the measured measurement variable, whereby the section of surface area comprises a coating that comprises nanoparticles.

There are coatings known in nanotechnology that effectuate a so called Lotus effect vis-à-vis water or aqueous solutions. By this is understood to mean the rolling-off of water from a surface, which in turn causes grime, which is transported by water, to be less capable of adhering to the coated surface. One such effect can be achieved by means of a coating that comprises nanoparticles, which effectuates a large angle of contact between the boundary surface of a water droplet on the surface and the coated surface. The Lotus effect is, among other things, taken advantage of through so called “nano-sealing” of glass and ceramic surfaces in the automotive or domestic sectors in order to reduce the adhering of grime or the accumulation of calk on glass panes, valves and instruments and to guarantee an easier cleanability. This sort of coating is described, by way of example, in DE 10 2006 023 375 A1.

The coating inhibits the accumulation of grime or biofilms on the coated section of surface area. The inventors were able to show experimentally that despite this coating, which changes the nature of the behavior of water on the coated section of surface area, reliable measurement values are retained.

The nanoparticles can comprise an average diameter of 1 to 900 nm, such as, for example, between 1 and 100 nm.

In a preferable embodiment, the coating that comprises the nanoparticles comprises at least one nano polymer. As to the fabrication of such a coating, suitable polymer dispersions (Latexes) are available, for, by way of example, sealing car windshields, sensitive or easily contaminated domestic surfaces, seeing glasses and electronic devices under the name of “Nanotol” from the company CeNano GmbH & Co. KG, Dorfen, Germany. Good results were also achieved with the glass sealant from the company Percenta AG, which is offered for the same purposes.

The coating can be a spray on coating, by way of example, which can be applied by simple means, after a cleaning, to the section of surface area that is to be coated.

The sensor, by way of example, can comprise an electrochemical sensor, whereby the section of surface area, which comprises the coating that comprises nanoparticles, comprises a measurement partition of the electrochemical sensor and/or a liquid junction of the electrochemical sensor, such as a diaphragm for example. The sensor can be embodied as a single rod measuring cell or also in the form of two separated half-cells. For pH measurements, the measurement partition can comprise a pH sensitive glass. For measuring the concentration of other substances, for example for the measurement of ion concentrations, the measurement partition can be embodied as an ion-sensitive ceramic or synthetic partition.

In a preferred embodiment, the sensor can be a potentiometric pH sensor, especially a pH single rod measuring cell with a glass electrode as measurement half-cell and an electrode of the second kind, for example an Ag/AgCl reference electrode, as a reference half-cell. The glass electrode comprises a pH sensitive partition. The reference half-cell comprises a liquid junction, which can, by way of example, be embodied as a porous diaphragm for establishing an electrolytic contact between the reference electrolytes contained in the reference half-cell and the measurement medium. In this embodiment, it is advantageous if the coating that comprises nanoparticles covers at least one portion of the glass partition and/or at least one portion of the liquid junction. In this way, on the one hand, contamination of and growths on the glass partition and the liquid junction are suppressed, and on the other hand, despite this coating, a reliable measurement value is retained.

The electrochemical sensor can also comprise an amperometric sensor, such as an oxygen sensor in accordance with the principle of the Clark-electrode as an example. In this case, the range of surface area, which is provided with a nanoparticle comprising coating, comprises a partition through which an analyte, such as O₂ or CO₂ for example, diffuses into a measurement chamber, wherein an amperometric measurement takes place.

Furthermore the sensor can be a redox sensor with at least one metal electrode. This can also, in the same way, be provided with the coating that comprises nanoparticles.

In an alternative embodiment, the sensor can be an optical sensor. In one variation, the sensor can comprise a section of surface area, which comprises the coating that comprises nanoparticles and which comprises windows or other optical elements, through which, for the registering of measurement variables, measurement radiation is emitted into the medium, or, through whose surface area, which is in contact with the medium, measurement signals are taken in/put out.

In a further variation of an optical sensor, the section of surface area, which comprises the coating that comprises nanoparticles, can comprise a partition, in which a substance is embedded, whose optical properties are influenced by the measurement variable of the medium. By way of example, the luminescence, the fluorescence and the absorption of the substance that is embedded in the partition can be variably dependent on the measurement variable of the medium.

In a further embodiment, the sensor can be an ISFET sensor, wherein at least one section of surface area, which comprises a coating that comprises nanoparticles, comprises at least the Gate of the ISFET.

The invention also comprises methods for the maintenance of a sensor, especially of a sensor of the sort in the above described embodiments. The method comprises the following steps:
Preparation of a solution, which comprises nanoparticles for a coating that comprises nanoparticles on at least one section of surface area, which is exposable to the medium for ascertaining the measurement variable, wherein the condition of the section of surface area affects the measurement variable representing measurement value provided by the sensor; and
Bringing the section of surface area in contact with the solution, so that a coating that comprises nanoparticles develops on the section of surface area.

The solution can, by way of example, be an aqueous dispersion from one or more nano polymers. For the fabrication of a nanoparticle-comprising, contaminant repellant coating, the section of surface area can be sprayed with the solution. It is in any case also possible to soak the section of surface area in the solution. After bringing the section of surface area in contact with the solution, an application time of the solution from 10 to 120 minutes, 60 minutes by way of example, can be provided.

In an advantageous embodiment, the solution can comprise a defined value, which can be registered as a measurement value by the sensor. In this case, the section of surface area can be soaked into the solution for doing a calibration and/or adjustment, while at the same time, the section of surface area that is soaked in the solution can develop a nanoparticle-comprising, contaminant repellant coating. For this, a measurement signal from the sensor is registered while the section of surface area stays in contact with the solution, and a calibration and/or an adjustment is made. If, by way of example, the sensor is a potentiometric sensor, e.g. a potentiometric pH sensor, the solution can be a buffer solution with a known pH value. With the help of the measured value, registered in the buffer solution and as the case may be, additionally used measured values, the offset and the slope of the sensor characteristic function, or more generally, the calibration curve of the sensor can be ascertained. With the help of the sensor characteristic function or the calibration curve ascertained in this way, the registered measurement signals registered by the later measurement function of the sensor can be mapped to the respective measurement values of the measurement variables, which are to be registered by the sensor. If the solutions used for calibration simultaneously contain nanoparticles for the developing of a contaminant repellent coating on the section of surface area, then coating can be applied or replenished/reconditioned during the calibration, so that no additional time and, likewise, no additional production steps are required for the application or replenishment/reconditioning of the coating.

Given that the previously mentioned sensors, especially the electrochemical sensors, must be recalibrated from time to time during their period of operation (“operating life”), the coating that comprises nanoparticles can be simultaneously, and in an efficient way, during the calibration, newly applied or reconditioned through the use of standard solutions for calibration, which are fabricated by admixing a nanoparticle comprising solution, especially a nano polymer comprising aqueous polymer dispersion. After the calibration, a further application time of the nanoparticle comprising solution can be provided for the curing of the coating.

The invention is illustrated in detail with the help of the pictured examples in the drawings. Although the illustrative examples are related to potentiometric pH sensors, the described embodiments and/or functions of the inventive coating are also apply to the other sensor types described above.

### LIST OF REFERENCE DRAWINGS

FIG. 1 a pH sensor embodied as a single rod measuring cell with a coating that comprises nanoparticles;

FIG. 2 depiction of four inventive pH sensors compared to four prior art/conventional pH sensors.

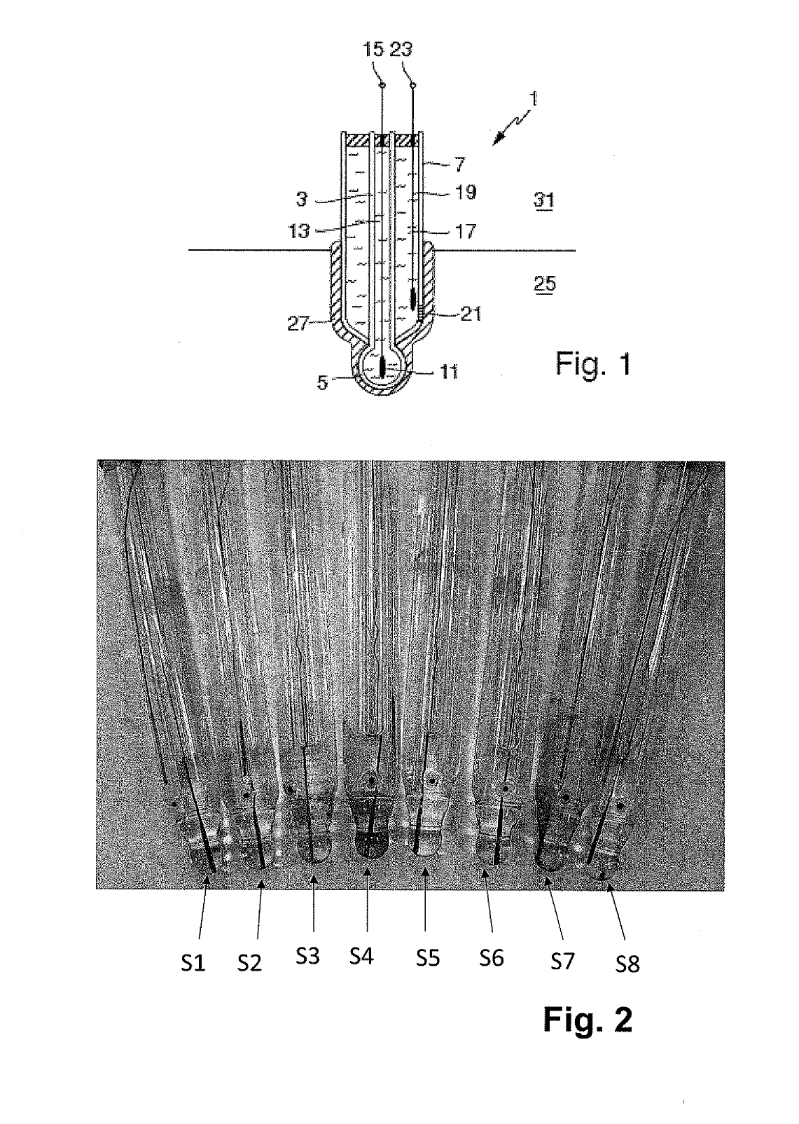

In FIG. 1, a pH sensor embodied as a single rod measuring cell 1 is shown. The pH sensor 1 comprises an electrically isolating housing, of glass by way of example, which comprises as a first housing part an electrically isolating inner tube 3 that is sealed off on one end by a pH sensitive glass partition 5. The inner tube 3 is surrounded by an electrically isolating, designed second housing part, shaft tube 7, wherein the shaft tube 7 is connected/conjoined to the inner tube 3 on its glass partition 5 facing end region, so that, situated around the inner tube 3, a complete, water tight separating and electrically isolating, ring chamber is comprised.

The inner housing chamber, enclosed by the glass partition 5 and the inner tube 3, is filled with a pH adjusted buffer solution 13 with a known pH value, wherein a first inner reference electrode 11, which comprises, by way of example, a chloridized silver wire, is submerged. The measurement half-cell of the pH sensor 1 formed in this way is electrically connected to a (not pictured) measurement circuit via an electrically conductive node, which is connected to the first inner reference electrode 11. The ring chamber formed between the inner tube 3 and the shaft tube 7 is filled with a reference electrolyte 17, such as a three molar aqueous potassium chloride solution for example. A second inner reference electrode 19 is immersed in the reference electrolyte 17, which can be embodied, just as the first inner reference electrode 11, as a silver chloride coated silver wire. In the shaft tube 7, a liquid junction 21, such as a diaphragm for example, is provided, which facilitates an exchange of charge carriers between the ring chamber and the surroundings, e.g. a medium 25, wherein the pH sensor 1 is immersed in order to carry out a measurement. The reference half-cell of the pH sensor, formed in this way, is electrically connected to the measurement circuit via a node 23 connected to the second inner reference electrode 19.

The measurement circuit comprises means for the determination of the difference in potential between the potential of the measurement half-cell, accessible on the first inner reference electrode, and the potential of the reference half-cell, accessible on the second inner reference electrode. The measurement electronics can be housed, by way of example, at least partially in an appropriate plug-in head on the pH sensor 1 or in a measuring transducer, which is can be connected to the pH sensor 1 electrically and/or for exchanging of information.

For the conducting of measurements, the pH sensor is submerged in a medium 25, whose pH value is to be determined and which is also described as measurement medium, so that the measurement partition 5 and the liquid junction 21 are in contact with the medium 25. The section of surface area of the pH sensor 1 that thereby comes into contact with the medium 25 is described as immersion range. The pH sensor 1, which is immersed in the medium 25, forms a galvanic cell with the medium 25, whose cell voltage is variably dependent on the hydrogen ion concentration, and accordingly, the pH value of the measurement medium. Thereby, the measurement partition 5 forms the hydrogen ion sensitive part of the pH sensor 1. The first inner reference electrode 11 forms a galvanic half element with the inner electrolytes 13, which is in electrical contact with the measurement solution via the glass partition 3, while the second inner reference electrode 19 forms a second galvanic element with the inner electrolytes 17 absorbed into the ring chamber between the shaft tube 7 and the inner tube 3 and is in contact with the medium 25 via the liquid junction 21. The measured electric potential difference between the electrical contacts 15 and 23 of the two inner reference electrode elements 11, 17 is thus a measure for the pH value of the medium 25.

On the outer surface of the pH sensor 1, a covering coating 27 is applied to the section of surface area designated for immersion in the medium 25. The coating comprises nanoparticles, which effectuate a lotus effect of the coated surface area in water or in aqueous solutions. This means that water and aqueous solutions form a large contact angle with the surface area in this region and thus roll off of the surface area. On the basis of the altered behavior of water on the coated section of surface area, contaminant particles contained in water cannot adhere to the section of surface area, or at least, can only do so in marginal quantities. In the same way, the development of a biofilm on the coated section of surface area immersed in the medium 25 is effectively suppressed.

It should be noted that the representation in FIG. 1 is purely schematic, and in particular, not to scale. The thickness of the coating 27 is marginal in comparison to the width of the glass partition, and accordingly, of the leach/hydrated layer of the glass partition or of the opening of the pores of the diaphragm comprised by the liquid junction 21. Accordingly, an adequate ionic conductivity is guaranteed through the glass partition and liquid junction. Furthermore, it was surprisingly demonstrated in experiments that the coating 27 had in no way a negative influence on the precision of the pH sensor 1. In particular, the characteristics of the potentiometric pH sensor, for example the offset and the slope of the sensor characteristic function, are comparable to those of the uncoated pH sensors.

However, in contrast to uncoated sensors, the coated glass partition remains free of contamination and growths. In this way, the operational life, and accordingly the duration of the distortion free operation of the sensors, is extended.

The coating 27 can be produced, by way of example, by applying a conventional glass sealant, intended for glass surfaces in the household or automotive sector, such as the previously mentioned glass sealant under the label Nanotol, which is commercially available, to the section of surface area that is to be coated. With regards to Nanotol, in accordance with manufacturers' instructions, nano polymer comprising aqueous polymer dispersions (latex) are involved. These are sprayed onto the section of surface area that is to be coated by means of a spray can. Because the solution contains no organic solvents or other harmful substances, this methodological step is altogether nonhazardous, and additionally, the disposal of the used chemicals is simple and inexpensive. After an application time of circa 60 minutes, the coated surface area is polished with a fuzz free towel.

As mentioned above, the coated sensors parameters offset and slope, ascertained after the coatings' application, are comparable to those of the uncoated pH sensors. At least 24 hours after the application of the sensor coating, these and other uncoated control/reference/comparison sensors were installed in an activated sludge tank in a sewage treatment plant and remained there for seven months. In FIG. 2, eight pH sensors are depicted after this timespan, exposed to contaminants in the sewage treatment plant, had elapsed, wherein the sensors S1, S2, S5, and S6 comprise the inventive coating, and the sensors S3, S4, S7, and S8 were inserted uncoated. It is plain to see that the uncoated sensors S3, S4, S7, and S8 comprise a grimy film in the immersion range, while the coated sensors S1, S2, S5, and S6 look virtually unaltered.

The use, described in the context of potentiometric pH sensors as an example, of a coating that comprises nanoparticles on a section of surface area, which is exposable to the medium for ascertaining the measurement variable, wherein the condition of the section of surface area affects the measurement variable representing measurement value provided by the sensor, is applicable to other types of sensors. In the same way, the ion selective partition and/or a section of surface area of an ion selective electrode comprising a liquid junction, a section of surface area of an ISFET sensor comprising a gate of an ISFET, or an electrode of a redox sensor that comes into contact with the medium or amperometric sensor as the case may be, can be protected from contamination with a coating that comprises nanoparticles.

A coating of this sort is also suitable for optical sensors for the avoidance of contamination of optical windows or other optical elements or for the avoidance of contamination of a sensor partition, which contains a substance whose optical properties change with a variable dependence on the measurement variables that are to be determined. Thereby, the measurement properties of the optical sensors are not impaired by the coating.

1-13. (canceled)

14. A sensor for registering a measurement variable of a medium, comprising:
a sensing body with a section of surface area, which is exposed to the medium to register the measurement variable, wherein:
the condition of said section of surface area affects the measurement variable representing measurement value provided by the sensor, characterized said section of surface area comprises a coating that comprises nanoparticles.

15. The sensor as claimed in claim 14, wherein:
said coating that comprises nanoparticles comprises at least one nano polymer.

16. The sensor as claimed in claim 14, wherein:
said coating effectuates a Lotus effect vis-à-vis water and/or aqueous solutions, so that the development of a film, especially of grime or a biofilm, is inhibited on said coated section of surface area.

17. The sensor as claimed in claim 14, wherein:
said coating is a spray-on coat.

18. The sensor as claimed in claim 14, wherein:
the sensor comprises an electrochemical sensor, such as for example, a potentiometric pH-meter embodied as a single rod measuring cell or in the form of two separated half-cells; and
the section of surface area, which comprises said coating that comprises nanoparticles, comprises a measurement partition of the electrochemical sensor and/or a diaphragm of the electrochemical sensor.

19. The sensor as claimed in claim 18, wherein:
the sensor is one of:
a pH sensor and an ion selective electrode.

20. The sensor as claimed in claim 19, wherein:
the sensor comprises a pH glass electrode with a pH sensitive glass partition; and
said coating that comprises nanoparticles at least partially covers said glass partition.

21. The sensor as claimed in claim 14, wherein:
the sensor is an optical sensor; and
the section of surface area, which comprises said coating that comprises nanoparticles, comprises windows or other optical elements, through which, for registering of measurement variables, measurement radiation is emitted into the medium, or, through whose surface area, which is in contact with the medium, measurement signals are taken in/put out.

22. The sensor as claimed in claim 14, wherein:
the sensor is an optical sensor; and
the section of surface area, which comprises said coating that comprises nanoparticles, comprises a partition, in which a substance is embedded, whose optical properties are influenced by the measurement variable of the medium.

23. The sensor as claimed in claim 14, wherein:
the sensor is an ISFET sensor; and
at least one section of surface area, which comprises said coating that comprises nanoparticles, comprises at least the Gate of the ISFET.

24. A method for the maintenance of a sensor, the sensor comprising:
a sensing body with a section of surface area, which is exposed to the medium to register the measurement variable, wherein:
the condition of said section of surface area affects the measurement variable representing measurement value provided by the sensor, characterized said section of surface area comprises a coating that comprises nanoparticles,
the method, comprising the steps of:
preparation of a solution, which comprises nanoparticles for forming a coating that comprises nanoparticles on at least one section of surface area of the sensor, which is exposable to the medium for registering the measurement variable, wherein the condition of the section of surface area affects the measurement variable representing measurement value provided by the sensor; and
bringing the section of surface area in contact with the solution, so that a coating that comprises nanoparticles develops on the section of surface area.

25. The method as claimed in claim 24, wherein:
the solution comprises a defined value to be registered as a measurement variable by the sensor.

26. The method as claimed in claim 25, further comprising the steps of:
registering of a measurement signal of the sensor while the section of surface area is in contact with the solution; and
calibration of the sensor by using the registered measurement signals.
